(19) United States
(12) Patent Application Publication
(10) Pub. No.: US 2025/0004460 A1
(43) Pub. Date: Jan. 2, 2025

(54) FAILURE PREDICTION DEVICE AND FAILURE PREDICTION METHOD FOR INDUSTRIAL EQUIPMENT USING MULTIPLE DEEP LEARNING MODELS SELECTIVELY

(71) Applicant: J SOLUTION CO., LTD., Daegu (KR)

(72) Inventor: Se Gi KWON, Daegu (KR)

(21) Appl. No.: 18/749,645

(22) Filed: Jun. 21, 2024

(30) Foreign Application Priority Data
Jun. 29, 2023 (KR) 10-2023-0084947

(51) Int. Cl. G05B 23/02

(52) U.S. Cl. CPC G05B 23/0254

(57) ABSTRACT

Provided is a failure prediction device and a failure prediction method for predicting failures in various types of industrial equipment with different operating characteristics or environments using multiple deep learning models selectively, which includes a sensor unit collecting operational data detecting an operating state of the industrial equipment; a data prediction unit provided with multiple deep learning-based prediction models and predicting the operational data of the industrial equipment during a second period after a first period using the operational data collected by the sensor unit; a prediction model selection unit comparing the operational data collected by the sensor unit during the second period with the operational data predicted by the multiple prediction models and selecting any one of the multiple prediction models; and a failure prediction unit predicting the occurrence time of failure of the industrial equipment using the operational data predicted by the selected operational data prediction model.

### BACKGROUND

### 1. Technical Field

The present disclosure relates to a failure prediction device and a failure prediction method for industrial equipment using multiple deep learning models selectively, and more particularly, to a failure prediction device and a failure prediction method for predicting failures in various types of industrial equipment with different operating characteristics or environments using multiple deep learning models selectively.

### 2. Related Art

Generally, industrial equipment used in various industrial sites includes various types of machine tools, such as milling machines, drill machines, and boring machines, for processing products and is gradually becoming faster and more precise to improve processing productivity and quality.

Among the industrial equipment, in particular, the machine tools for processing materials are factors that determine the quality of manufactured products. Tool breakage and tool wear are known to be typical causes of machine tool failure. Using the broken and worn tools may cause defects of workpieces produced using the machine tools.

The tool breakage is a phenomenon in which a tool breaks and becomes unusable, causing fatal damage to the workpieces and machine tools during the breakage. The tool wear inevitably occurs as the tools wear out due to friction during the process of manufacturing workpieces. When workpieces are manufactured with tools worn out, the quality of the workpieces may not reach the acceptable criterion, resulting in the production of defective products.

Therefore, the sudden failure or abnormality of machine tools causes decreases in product yield, quality, etc., which significantly reduces productivity. Most conventional methods of determining abnormalities or failures of tools are accomplished by allowing a field worker to periodically stop machine tools in a factory and remeasure dimensions of a workpiece, but incurs the problem of risking higher probability of inaccurate measurements.

In order to solve these problems of the related art, technology has recently been developed to collect operation data of machine tools using sensors to diagnose or determine whether the machine tools are broken.

An example of the technology is disclosed in Korean Patent Publication No. 10-2021-0141087 (published on Nov. 23, 2021).

However, the technologies disclosed in the gazette and the like are applied to determine whether a failure has occurred at the current time using machine tool operation data collected before the determination time of failure. In this method, the failure of the machine tools is detected after the machine tools have already broken down and product defects have occurred, and therefore, this was only an after-the-fact measure and was still insufficient to prevent damage caused by the failure of the machine tool.

Therefore, there is a need to develop a device that may accurately predict the possibility of failure before a failure occurs in various types of industrial equipment.

### SUMMARY

The present disclosure provides a failure prediction device and a failure prediction method capable of improving accuracy of failure prediction for various types of industrial equipment with different operating characteristics or environments using multiple deep learning-based time series prediction models selectively.

According to an embodiment of the present disclosure, a failure prediction device for industrial equipment using multiple deep learning models selectively includes: a sensor unit that collects operational data detecting an operating state of the industrial equipment; a data prediction unit that is provided with multiple deep learning-based prediction models and predicts the operational data of the industrial equipment during a second period after a first period using the operational data collected by the sensor unit during the first period; a prediction model selection unit that compares the operational data collected by the sensor unit during the second period with the operational data predicted by the multiple prediction models and selects any one of the multiple prediction models as an operational data prediction model of the industrial equipment; and a failure prediction unit that predicts an occurrence time of failure of the industrial equipment using the operational data predicted by the selected operational data prediction model.

The failure prediction device may further include an autoencoder model-based data preprocessing unit that extracts features of the operational data collected by the sensor unit and provides the extracted features as an input layer of the prediction model. The multiple prediction models may include a long short term memory (LSTM) model, a transformer model, and a temporal convolution network (TCN) model.

The prediction model selection unit may select a prediction model with a smallest mean squared error (MSE) value of the operational data collected by the sensor unit during the second period and the operational data predicted by the multiple prediction models as the operational data prediction model of the industrial equipment.

The failure prediction unit may determine whether any one of the predicted operational data exceeds a preset tolerance range for the corresponding operational data to predict the occurrence time of failure of the industrial equipment.

The failure prediction unit may use the operational data as an input layer to predict the occurrence time of failure of the industrial equipment using the deep learning model that is trained to determine whether the industrial equipment has failed.

According to another embodiment of the present disclosure, a failure prediction method of industrial equipment using multiple deep learning models selectively includes: (a) collecting operation data by detecting or measuring an operating state of the equipment through a sensor unit; extracting features of operational data from a data preprocessing unit for the operational data collected in (a); (c) applying, by a data prediction unit, multiple prediction models according to the features extracted in (b) to predict future operational data for the equipment; selecting, by a prediction model selection unit, an operational data prediction model for the corresponding industrial equipment from among the multiple prediction models used for prediction in (c); and (e) predicting, by the failure prediction unit, an occurrence time of failure of the corresponding industrial equipment using the operational data prediction model selected in (d).

### BRIEF DESCRIPTION OF DRAWINGS

FIG. 1 is a block diagram illustrating an overall configuration of a failure prediction device for industrial equipment using multiple deep learning models selectively according to an embodiment of the present disclosure.

FIG. 2 is a block diagram of a sensor unit illustrated in FIG. 1.

FIG. 3 is a diagram illustrating a structure of an autoencoder applied to a data preprocessing unit of FIG. 1.

FIGS. 4A-4C are diagrams illustrating a structure of a long short term memory (LSTM) model, a transformer model, and a temporal convolution network (TCN) model which are prediction models mounted on a data prediction unit of FIG. 1.

FIGS. 5 to 7 are diagrams for describing time series data prediction characteristics of the prediction model mounted on the data prediction unit of FIG. 1.

FIG. 8 is a process diagram for describing a process of predicting failure of industrial equipment using multiple deep learning models selectively according to the present disclosure.

### DESCRIPTION OF EXAMPLE EMBODIMENTS

The above and other objects and new features of the present disclosure will become clearer by the description of this specification and the accompanying drawings.

First, the terms “member,” “module,” and “unit” used herein perform at least one function or operation and may be implemented as hardware or software composed of a mechanical, electrical, or electronic configuration, or as a combination of hardware and software, and multiple “members” and “modules” or multiple “units” may be integrated into at least one module, except for “members”, “modules” or “units” that need to be implemented with specific hardware and implemented as at least one processor.

In addition, throughout the detailed description and claims of the present disclosure, “industrial equipment” is a concept including not only machines for processing parts or products such as milling, boring, and drilling, but also all equipment used in industrial sites such as press equipment, injection equipment, and casting equipment.

In addition, throughout the detailed description and claims of the present disclosure, “operational data” is data representing an operating state of industrial equipment, and refers to the vibration, noise, temperature, pressure, current, voltage, power amount, speed, rotation speed (rpm), etc., of the equipment measured by the sensor.

The deep learning-based failure prediction device for industrial equipment according to the present disclosure is a technology for accurately predicting the operational data of the equipment for a future time period after the current time using collected operational data about the industrial equipment, and predicting the occurrence of failure from the predicted operational data in advance, which may be an important core technology for smart manufacturing innovation.

In this embodiment, for convenience of description, for example, the description is limited to the case where the “industrial equipment” is a machine tool for processing parts or products that mainly performs rotational or linear motion by a motor or the like.

Hereinafter, embodiments according to the present disclosure will be described with reference to the accompanying drawings.

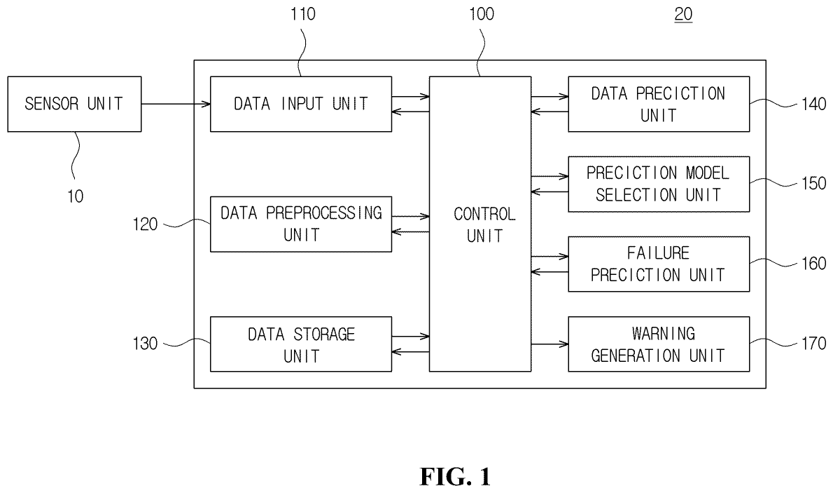

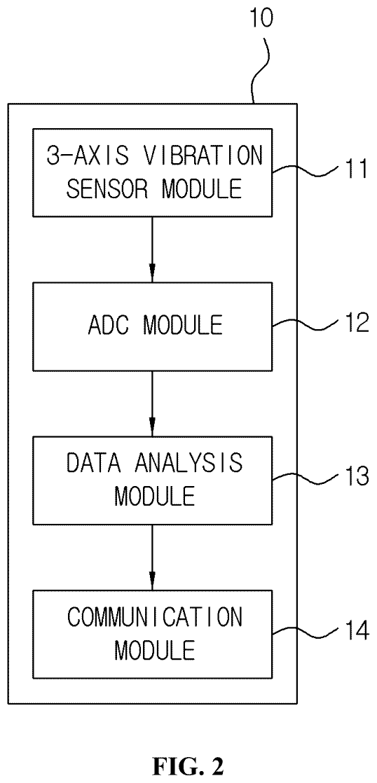

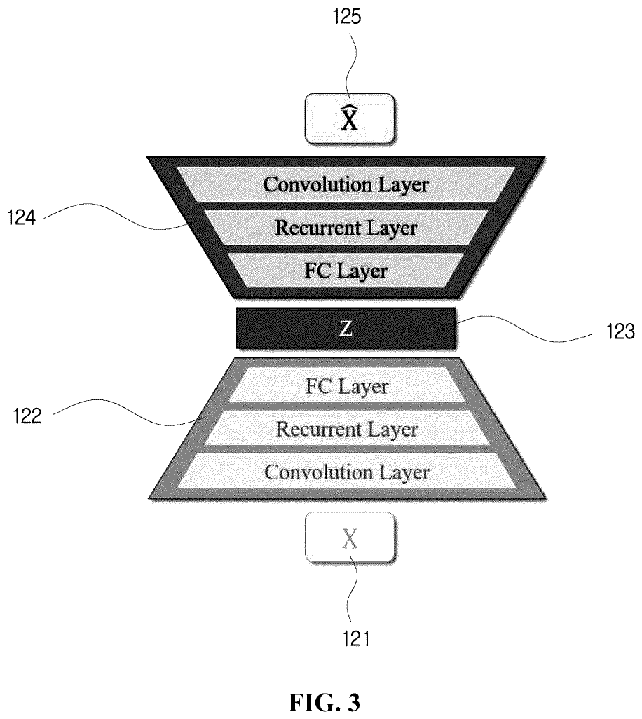

FIG. 1 is a block diagram illustrating an overall configuration of a failure prediction device for industrial equipment using multiple deep learning models selectively according to an embodiment of the present disclosure, FIG. 2 is a block diagram of a sensor unit illustrated in FIG. 1, and FIG. 3 is a diagram illustrating a structure of an autoencoder applied to a data preprocessing unit of FIG. 1.

As illustrated in FIG. 1, the failure prediction device for industrial equipment selectively using multiple deep learning models according to the present disclosure includes a sensor unit 10 that collects operational data detecting an operating state of industrial equipment, and a failure prediction module 20 that predicts the operational data of the corresponding equipment using the operational data collected by the sensor unit 10 and predicts the occurrence time of failure from the predicted operational data.

The sensor unit 10 is installed on one side of the industrial equipment and provided to collect the operational data by detecting or measuring the operating state of the equipment. As an example, as illustrated in FIG. 2, the sensor unit 10 may include a 3-axis vibration sensor module 11 that is provided with a vibration sensor or an acceleration sensor that measures vibration in a 3-axis direction of a machine tool performing rotation or linear motion of the industrial equipment, an analog-to-digital converter (ADC) module 12 for A/D conversion of the output of the 3-axis vibration sensor module 11, a data analysis module 13 that calculates the above-described operational data by performing fast Fourier transform (FFT) analysis on data converted by the ADC module 12, and a communication module (not illustrated) that transmits the operational data calculated by the data analysis module 13 to the failure prediction module 20.

Therefore, the operational data may include the output of the 3-axis vibration sensor. As an example, the operational data may include a vibration value in the X-axis direction, skewness in the X-axis direction, kurtosis in the X-axis direction, and a crest factor in the X-axis direction, vibration value in the Y-axis direction, skewness in the Y-axis direction, kurtosis in the Y-axis direction, and a crest factor in the Y-axis direction, and a vibration value in the Z-axis direction, skewness in the Z-axis direction, kurtosis in the Z-axis direction, and a crest factor in Z-axis direction.

The term “skewness” refers to the asymmetry of the probability distribution. As the bias (the degree to which the distribution of signal values is concentrated to one side based on the average of the signal) of the vibration signal increases, the skewness increases, that is, the result of the skewness is a major factor in predicting equipment failure.

In addition, the term “kurtosis” refers to the degree to which the probability distribution is steep. As vibration signal values are distributed with values close to a specific value and the distribution thereof has a pointed form, the kurtosis increases, that is, the result of kurtosis may be a major factor in predicting equipment failure.

In addition, the crest factor is defined as a ratio of peak (maximum amplitude) and root mean square (RMS) with respect to the measurement time T. The stronger (or random vibration) the vibration, the higher the crest factor, that is, the crest factor is the measurement of harmful components of vibration and may be a major factor in predicting equipment failure.

As illustrated in FIG. 1, the failure prediction module 20 may include a data input unit 110 to which the operational data transmitted from the sensor unit 10 is input, a data preprocessing unit 120 that extracts the features of the input operational data, a data storage unit 130 in which the operational data and the characteristics of the operational data are stored, a data prediction unit 140 that predicts the operational data of the industrial equipment using the operational data, a prediction model selection unit 150 that selects any one of the multiple prediction models as a prediction model for motion data of the industrial equipment, a failure prediction unit 160 that predicts when the failure occurs in the corresponding equipment using the predicted operational data, and a control unit 100 that controls the operation of the above-described components.

The data input unit 110 may be connected to communicate with the communication module 14 of the sensor unit 10 by either wired or wireless communication and configured to receive the operational data from the sensor unit 10.

The data preprocessing unit 120 is configured to extract the features of the operational data input to the data input unit 110 using the autoencoder model having the structure illustrated in FIG. 3 and input the extracted features to the features of the input layer (specifically, the input layer of the prediction models to be described later) of the data prediction unit 140.

The autoencoder is a deep learning model using unsupervised learning of an artificial neural network and is mainly used to extract feature points by reducing the dimension of the input layer data or to determine whether there is an abnormality in the data by comparing the output layer data obtained by restoring data with reduced dimensionality with the input layer data.

As illustrated in FIG. 3, the autoencoder model may include an encoder 122 that compresses the data of the input layer 121 to obtain a latent variable 123, and a decoder 124 that restores the latent variable 123 to obtain the data of the output layer 125, and the latent variable 123 corresponds to the features of the data of the input layer 121.

Therefore, in this embodiment, the data preprocessing unit 120 is configured to extract the features (i.e., latent variable 123) of the operational data, which is the input layer 121 data, by the encoder 122 and provide the extracted features to the data prediction unit 140 as described below.

The data prediction unit 140 performs a function of predicting future operational data using previously collected operational data for the corresponding equipment.

In the case of the conventional deep learning-based data prediction system, it is common to apply one deep learning model. However, in the case of the equipment used at industrial sites, the operation method is different depending on the type, and even in the case of the same equipment, the operating environment is different. Therefore, when the same data prediction system is applied to all the equipment, a problem may arise in which data prediction accuracy varies depending on the equipment.

The present disclosure is intended to solve this problem, and compares the operational data of the industrial equipment predicted using the multiple deep learning-based time series prediction model with the actually measured operational data of the equipment, and selects the prediction model with the smallest error value as the operational data prediction model for predicting the failure of the corresponding equipment. Therefore, the present disclosure may improve the accuracy of the failure prediction for various types of industrial equipment with different operating characteristics or environments.

To this end, the data prediction unit 140 is configured to include the multiple deep learning-based prediction models that uses the operational data collected by the sensor unit 10 during a first period, which is a time period before the current time, to predict the operational data of the industrial equipment during a second period after the first period (i.e., after the current time).

In general, the deep learning-based prediction models for predicting the time series data include recurrent neural network (RNN) series models such as a long short term memory (LSTM) and a gated recurrent unit (GRU), an attention-based transformer model, convolutional neural network (CNN)-based models such as a temporal convolutional network (TCN) and a graph convolutional network (GCN), and each of these prediction models exhibits unique data prediction characteristics.

Therefore, in the present disclosure, as described above, the operational data predicted by the multiple prediction models for specific equipment are compared with the actually measured operational data, and selects the optimal prediction model for the corresponding equipment to predict operational data in the future.

In this embodiment, for convenience of description, an example of the case where the multiple prediction models mounted on the data prediction unit 140 include an RNN-based LSTM model, an attention-based transformer model, and a CNN-based TCN model is described, but the present disclosure is not limited thereto, and the multiple prediction model may include other time series prediction models or further include them as needed within the scope of application of the technical idea of the present disclosure.

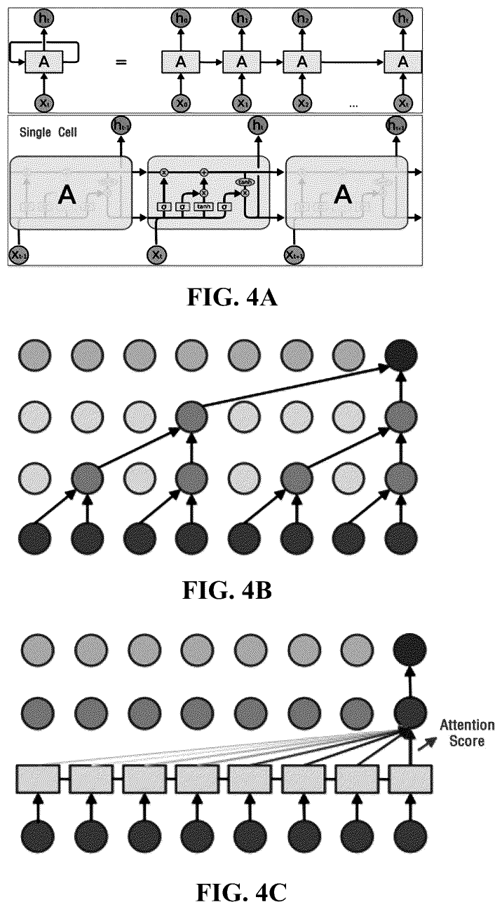

FIGS. 4A-4C illustrate examples of the prediction model mounted on the data prediction unit of FIG. 1, and FIG. 4A illustrates a structure of the LSTM model, FIG. 4B illustrates a structure of the transformer model, and FIG. 4C illustrates a structure of the TCN model. Meanwhile, FIGS. 4A-4C illustrate the architectural structures of the LSTM model, the transformer model, and the TCN model, but since the prediction model is the known model, a detailed description thereof will be omitted.

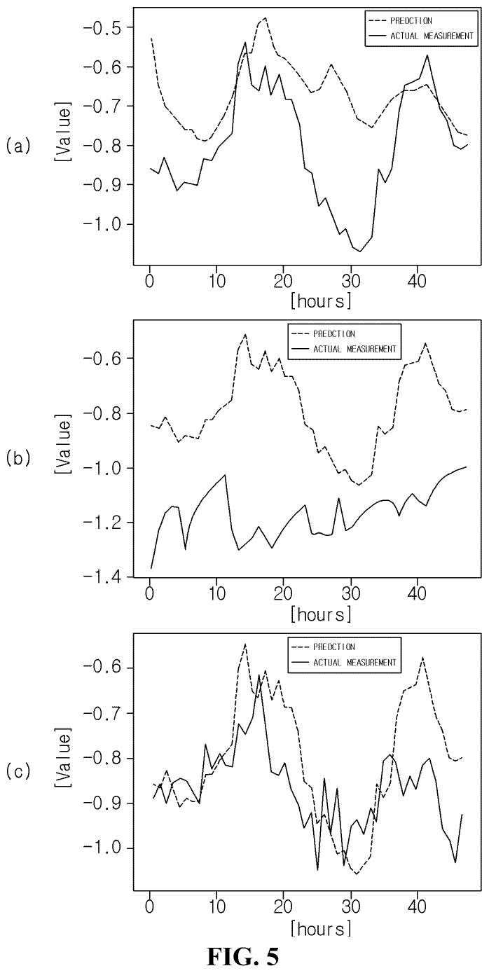

In addition, FIGS. 5 to 7 illustrate test results to confirm the data prediction characteristics of the three prediction models.

In FIG. 5, the results of predicting the X-axis vibration value during the next 48 hours (second period) using the X-axis vibration value collected during the previous 48 hours (first period) and the results of comparing the actually measured X-axis vibration values during the second period after the data prediction are illustrated for each prediction model. FIG. 5A illustrates the LSTM model, FIG. 5B illustrates the transformer model, and FIG. 5C illustrates the TCN model.

In addition, in FIG. 6, the results of predicting the Z-axis vibration value during the next 48 hours (second period) using the Z-axis vibration value collected during the previous 48 hours (first period) and the results of comparing the actually measured Z-axis vibration values during the second period after the data prediction are illustrated for each prediction model. (a) in FIG. 6 illustrates the LSTM model, (b) in FIG. 6 illustrates the transformer model, and (c) in FIG. 6 illustrates the TCN model.

Finally, in FIG. 7, the results of predicting the Y-axis vibration value during the next 196hours (second period) using the Y-axis vibration value collected during the previous 48 hours (first period) and the results of comparing the actually measured Y-axis vibration value during the second period after the data prediction are illustrated for each prediction model. FIG. 7A illustrates the LSTM model, FIG. 7B illustrates the transformer model, and FIG. 7C illustrates the TCN model.

As illustrated in FIGS. 5 to 7, each prediction model illustrates different data prediction characteristics even for the same equipment.

Broadly speaking, the TCN model was shown to have relatively excellent accuracy when making the long-term prediction. In addition, in the case of the general operational data upon the short-term prediction, the LSTM model was shown to have relatively excellent accuracy, and in case of the operational data with clear patterns or periodicity, the transformer model was shown to have relatively excellent accuracy.

In order to select the most optimal prediction model for the corresponding equipment according to the prediction characteristics of each model, the prediction model selection unit 150 may compare the operational data collected by the sensor unit 10 during the second period with the operational data predicted by the multiple prediction model to select any one of the multiple prediction models as the operational data prediction model of the industrial equipment.

In addition, the prediction model selection unit 150 may select the prediction model with the smallest mean squared error (MSE) value of the operational data collected by the sensor unit during the second period and the operational data predicted by the multiple prediction models as the operational data prediction model of the industrial equipment. The mean square error is obtained as the average of the value obtained by squaring the error. The smaller the mean square error, the higher the accuracy of the predicted value.

In addition, the failure prediction unit 160 predicts the occurrence time of failure of the industrial equipment using the operational data predicted in the operational data prediction model selected by the prediction model selection unit 150.

The failure prediction unit 160 may determine whether any one of the predicted operational data exceeds a preset tolerance range for the corresponding operational data to predict the occurrence time of failure of the industrial equipment. In the case of this embodiment, the failure prediction unit 160 is also configured to predict the occurrence time of failure using the deep learning model.

That is, the failure prediction unit 160 uses the operational data as the input layer to predict the occurrence timing of failure of the industrial equipment using the deep learning model trained to determine whether the industrial equipment has failed. In this case, the applied deep learning model may include any one of the RNN series learning model, the CNN series learning model, or the DNN series learning model.

In addition, as a result of the determination of the failure prediction unit 160, the control unit 100 generates a warning composed of a text message, an alarm, etc., through a warning generation unit 170 so that the equipment manager may confirm when the occurrence possibility of failure is predicted at a certain time.

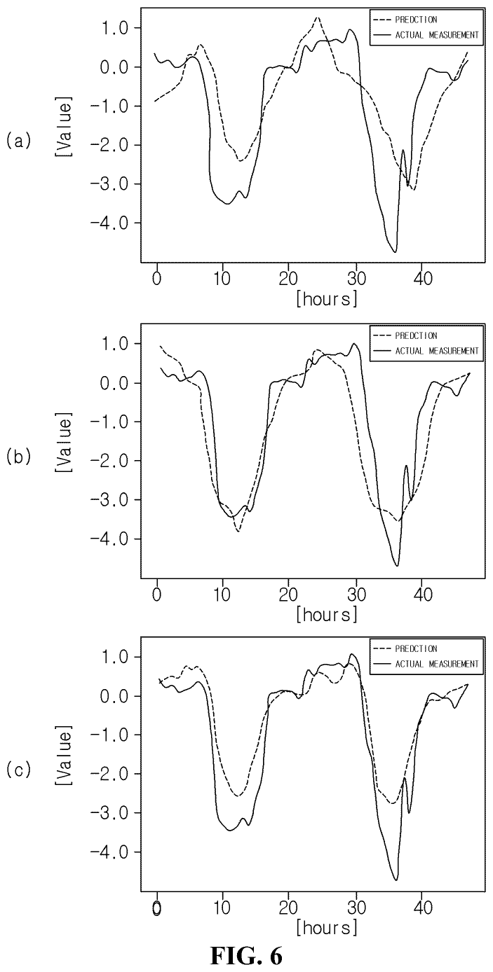

Next, the failure prediction method of industrial equipment using multiple deep learning models selectively according to the present disclosure will be described with reference to FIG. 8.

FIG. 8 is a process diagram for describing a process of predicting failure of industrial equipment using multiple deep learning models selectively according to the present disclosure.

First, the operational data is collected by detecting or measuring the operating state of the industrial equipment through the sensor unit 10 installed on one side (S10).

The operational data collected through the sensor unit 10 in S10 is transmitted to the data input unit 110 of the failure prediction module 20 through the communication module 14, and the data preprocessing unit 120 extracts the features of the operational data input to the data input unit 110 and transmits the extracted features to the input layer of the data prediction unit 140. That is, the data preprocessing unit 120 may extract the features of the operational data detected or measured by the sensor unit 10 (S20).

According to the features of the operational data extracted in step S20, the data prediction unit 140 predicts the future operational data for the corresponding equipment using the operational data collected by the sensor unit 10 (S30). That is, the data prediction unit 140 applies the mounted multiple models, such as an RNN-based LSTM model, an attention-based transformer model, and a CNN-based TCN model, respectively, to predict the future operational data.

Subsequently, the prediction model selection unit 150 may select the prediction model with the smallest mean square error (MSE) value of the operational data collected by the sensor unit 10 and the operational data predicted by the multiple prediction model in the data prediction unit 140 as the operational data prediction model of the corresponding industrial equipment (S40).

Next, the failure prediction unit 160 predicts the occurrence time of failure of the industrial equipment using the operational data predicted in the operational data prediction model selected by the prediction model selection unit 150 (S50), and as a result of the determination of the failure prediction unit in S50, the control unit 100 may generate a warning composed of a text message or an alarm through the warning generation unit 170 so that the equipment manager may confirm when the occurrence possibility of failure of the equipment is predicted at a specific time.

Meanwhile, regarding the accuracy of the failure prediction device according to the present disclosure, tests were conducted on three items, including the accuracy of the operational data prediction value, the effective prediction period, and the accuracy of the failure prediction.

As a result of the test, in the case of the failure prediction device according to the present disclosure, the accuracy of the operational data prediction value was shown to be excellent with an average MSE of 0.8235 (based on 1.0 or less), and the prediction of the operational data was found to be possible for up to 30 days while maintaining a certain level of accuracy. In addition, the accuracy of failure prediction of the equipment using the operational data was shown to be excellent, with a detection rate of 0.9627, exceeding 90%.

As described above, the failure prediction device for industrial equipment that selectively uses multiple deep learning models according to the present disclosure is configured to compare the data predicted by the multiple time series prediction models with the actual operational data for the prediction time interval when predicting operational data of equipment to predict the point of future failure to select the optimal prediction model with the smallest error, thereby securing the data prediction accuracy for various types of industrial equipment with different operating characteristics and environments.

According to the failure prediction device and failure prediction method for industrial equipment according to the present disclosure, when predicting the operational data of equipment to predict the occurrence time of failure in the future, since the multiple time series prediction models are configured to compare the predicted data with the actual operational data for the prediction time interval to select the optimal prediction model with the smallest error, it is possible to secure the accuracy of data prediction for various types of industrial equipment with different operating characteristics and environments.

What is claimed is:

1. A failure prediction device for industrial equipment using multiple deep learning models selectively, comprising:
a sensor unit that collects operational data detecting an operating state of the industrial equipment;
a data prediction unit that is provided with multiple deep learning-based prediction models and predicts the operational data of the industrial equipment during a second period after a first period using the operational data collected by the sensor unit during the first period;
a prediction model selection unit that compares the operational data collected by the sensor unit during the second period with the operational data predicted by the multiple prediction models and selects any one of the multiple prediction models as an operational data prediction model of the industrial equipment; and
a failure prediction unit that predicts an occurrence time of failure of the industrial equipment using the operational data predicted by the selected operational data prediction model.

2. The failure prediction device of claim 1, further comprising an autoencoder model-based data preprocessing unit that extracts features of the operational data collected by the sensor unit and provides the extracted features as an input layer of the prediction model.

3. The failure prediction device of claim 1, wherein the multiple prediction models include a long short term memory (LSTM) model, a transformer model, and a temporal convolution network (TCN) model.

4. The failure prediction device of claim 2, wherein the multiple prediction models include an LSTM model, a transformer model, and a TCN model.

5. The failure prediction device of claim 1, wherein the prediction model selection unit selects a prediction model with a smallest mean squared error (MSE) value of the operational data collected by the sensor unit during the second period and the operational data predicted by the multiple prediction models as the operational data prediction model of the industrial equipment.

6. The failure prediction device of claim 2, wherein the prediction model selection unit selects a prediction model with a smallest mean squared error (MSE) value of the operational data collected by the sensor unit during the second period and the operational data predicted by the multiple prediction models as the operational data prediction model of the industrial equipment.

7. The failure prediction device of claim 1, wherein the failure prediction unit determines whether any one of the predicted operational data exceeds a preset tolerance range for the corresponding operational data to predict the occurrence time of failure of the industrial equipment.

8. The failure prediction device of claim 2, wherein the failure prediction unit determines whether any one of the predicted operational data exceeds a preset tolerance range for the corresponding operational data to predict the occurrence time of failure of the industrial equipment.

9. The failure prediction device of claim 1, wherein the failure prediction unit uses the operational data as an input layer to predict the occurrence time of failure of the industrial equipment using the deep learning model that is trained to determine whether the industrial equipment has failed.

10. The failure prediction device of claim 2, wherein the failure prediction unit uses the operational data as an input layer to predict the occurrence time of failure of the industrial equipment using the deep learning model that is trained to determine whether the industrial equipment has failed.

11. A failure prediction method of industrial equipment using multiple deep learning models selectively, comprising:
(a) collecting operation data by detecting or measuring an operating state of the equipment through a sensor unit;
(b) extracting features of operational data from a data preprocessing unit for the operational data collected in (a);
(c) applying, by a data prediction unit, multiple prediction models according to the features extracted in (b) to predict future operational data for the equipment;
(d) selecting, by a prediction model selection unit, an operational data prediction model for the corresponding industrial equipment from among the multiple prediction models used for prediction in (c); and
(e) predicting, by the failure prediction unit, an occurrence time of failure of the corresponding industrial equipment using the operational data prediction model selected in (d).

12. The failure prediction device of claim 11, wherein, in (d), the prediction model selection unit selects the prediction model with a smallest mean squared error (MSE) value of the operational data collected in (a) and the operational data predicted in (c) as a prediction model for operational data of industrial equipment.

13. The failure prediction device of claim 12, wherein, in (d), the multiple prediction models include a long short term memory (LSTM) model, a transformer model, and a temporal convolution network (TCN) model.
